(19) United States
(12) Patent Application Publication
(10) Pub. No.: US 2012/0297831 A1
(43) Pub. Date: Nov. 29, 2012

(54) METHOD AND INSTALLATION FOR MANUFACTURING A GLASS BOTTLE

(75) Inventors: Antoine BRUNEAU, EU (FR); Sébastien GUÉROUT, MONCHAUX SORENG (FR); Jean-Marie PRUVOST, BEAUCAMPS LE VIEUX (FR); Sebastien BALITEAU, BOUTTENCOURT (FR)

(73) Assignee: POCHET DU COURVAL, PARIS (FR)

(21) Appl. No.: 13/476,103

(22) Filed: May 21, 2012

(30) Foreign Application Priority Data
May 23, 2011 (FR) 11 54464

(51) Int. Cl. C03B 9/193; C03B 23/24

(52) U.S. Cl. 65/44; 65/47; 65/48; 65/46; 65/156

(57) ABSTRACT

The installation for manufacturing a glass bottle (1) comprises a blank mould (10) formed of two semi-shells (10a and 10b) each comprising a cavity (11) of shape substantially corresponding to the outer shape of a semi-body of the body of the bottle, means for depositing a gob of glass (8) in the cavity (11) of each semi-shell (10a, 10b), two punches each able to be moved between a passive position and an active applied position in the cavity (11) of the corresponding semi-shell (10a, 10b) to distribute the glass within the cavity (11) and define the walls of each semi-body, and means for applying the edges of the two semi-bodies against one another by applying a determined pressure to hot-weld together these edges of the two semi-bodies and to obtain the bottle.

The present invention concerns a method and installation for manufacturing a glass bottle comprising in particular a bottom, side walls and optionally a ring opposite the said bottom.

In general, glass bottles are obtained by placing at least one gob of glass also known as a parison into a cavity of a blank mould and pre-forming a blank by blowing air for example into this blank mould.

The blank thus formed is released from the mould and transferred e.g. via a manipulator arm to a finishing mould into which air is blown for final forming of the bottle.

The main disadvantage of this method is that it does not allow one or more raised or recessed patterns to be imprinted on the inner surface of at least one wall of the bottle. Some glass bottle users, in particular in the perfume or cosmetic fields, seek to personalize their bottle by having raised and/or recessed patterns on the inside, recalling or suggestive of the trademark and/or the product contained in the bottles. The inside pattern or patterns may be independent of the shape of the bottle and, for example, these patterns may have particular optical effects.

It is the objective of the invention to propose a method and installation for manufacturing glass bottles allowing this type of patterning inside these bottles.

The subject of the invention is therefore a method for manufacturing a glass bottle comprising a body which particularly includes a bottom with side walls, characterized in that it consists of the following steps:

a) at least one gob of glass is deposited in a cavity of a first semi-shell of a blank mould, and at least one gob of glass is deposited in a cavity of a second semi-shell of the blank mould, each cavity having a shape substantially corresponding to the outer shape of a semi-body of the said body;

b) the semi-body is formed in the cavity of each semi-shell by applying a punch to distribute the glass within the corresponding cavity and to define the walls of each semi-body; and

c) the edges of the two semi-bodies are applied against each other by applying a pre-determined pressure to hot-weld the edges of the two semi-bodies with one another and to obtain the bottle.

The method of the invention may comprise one or more of the following characteristics taken alone or in any possible technical combination:
in the cavity of a semi-shell, a semi-body is formed provided with a ring;
in the cavity of each semi-shell, a semi-body is formed provided with a semi-ring so that, after hot welding the edges of the semi-bodies and semi-rings, a bottle is obtained comprising a body provided with a ring;
by means of at least one of said punches, at least one raised or recessed pattern is formed on an inner surface of at least one wall of at least one semi-body;
by means of said punches, at least one raised or recessed pattern is formed on an inner surface of at least one wall of each semi-body;
step c) is conducted directly in the blank mould by applying the two semi-shells against each other;
after step b), the two semi-bodies are transferred to a finishing mould and step c) is performed;
after step b), the two semi-bodies are extracted from the two shells of the blank mould and step c) is performed;
after step c), the body is transferred to a finishing mould and at least one finishing step is performed; and
before step c), the edges of the two semi-bodies are re-heated and said step c) is performed.

A further subject of the invention is an installation for manufacturing a glass bottle to implement the method such as previously mentioned, characterized in that it comprises:
a blank mould formed of two semi-shells each comprising a cavity whose shape substantially corresponds to the outer shape of a semi-body of said body;
means for depositing at least one gob of glass in the cavity of each semi-shell;
at least one punch which can be moved between a passive position and an active applied position in the cavity of each semi-shell to distribute the glass within the cavity and define the inner walls of each semi-body; and
means for applying the edges of the two semi-bodies against one another by applying a determined pressure to hot-weld these edges of the two semi-bodies with each other and to obtain the bottle.

The installation of the invention may comprise one or more of the following characteristics taken alone or in any possible technical combination:
at least one of the two punches comprises at least one raised or recessed pattern to form the said at least one raised or recessed pattern on an inner surface of at least one wall of at least one semi-body;
the means for applying together the edges of the two semi-bodies are formed by the two semi-shells of the blank mould;
the installation comprises means for transferring each semi-body to a semi-shell of a finishing mould, and the means for applying together the edges of the walls of the two semi-bodies are formed by the two semi-shells of the finishing mould; and
the installation comprises at least one element for re-heating the edges of the two semi-bodies before applying these edges of the two semi-bodies against one another.

The characteristics and advantages of the invention will become apparent from the following description given as an example with reference to the appended drawings in which:

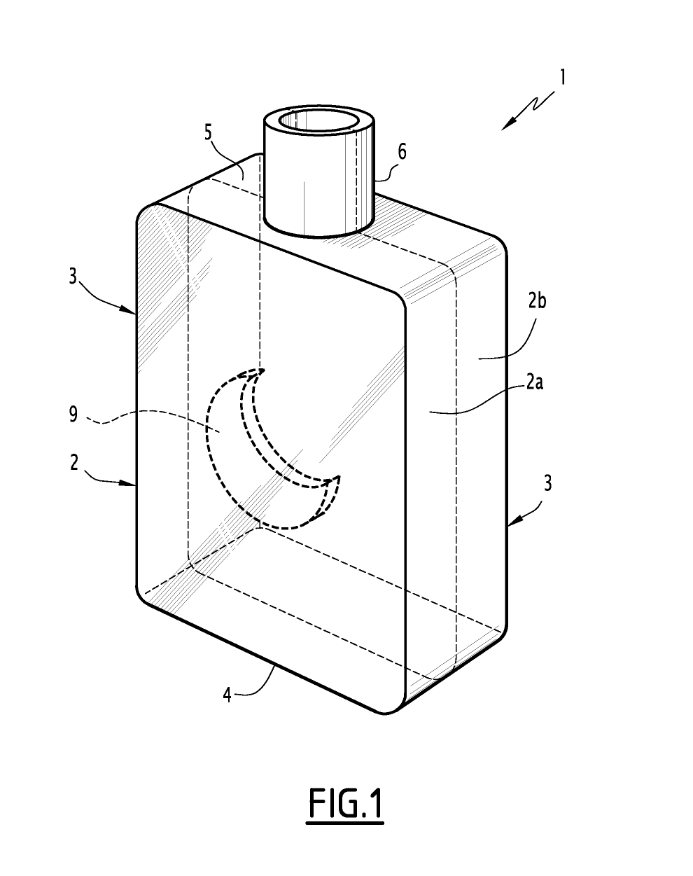

FIG. 1 is a schematic, perspective view of a glass bottle obtained using a manufacturing installation conforming to the invention;

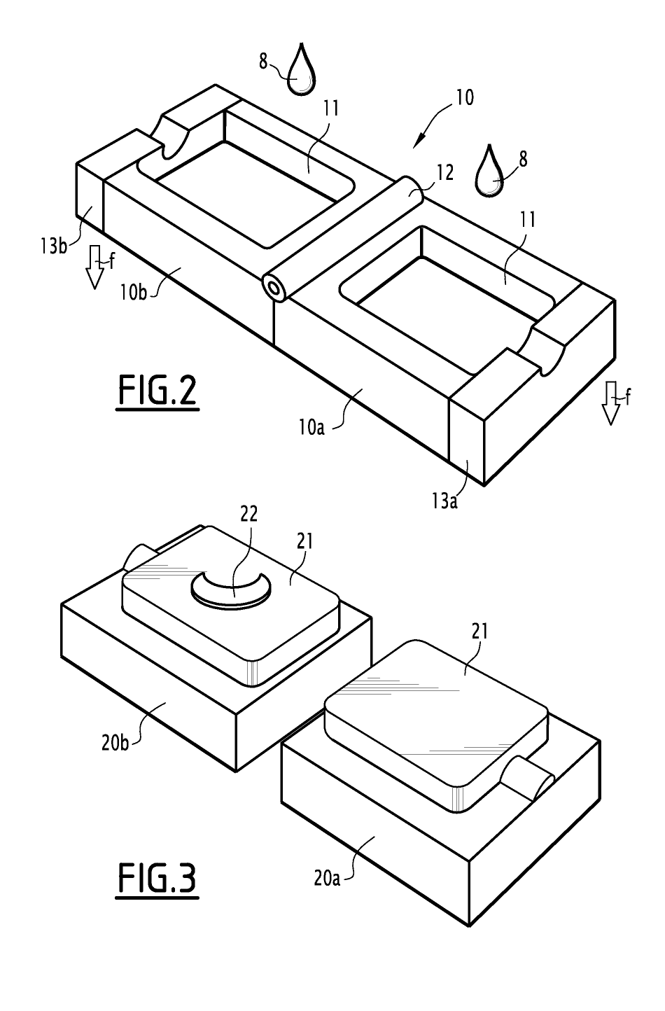

FIG. 2 is a schematic, perspective view of a blank mould of the manufacturing installation conforming to the invention;

FIG. 3 is a schematic, perspective view of the punches of the manufacturing installation conforming to the invention; and

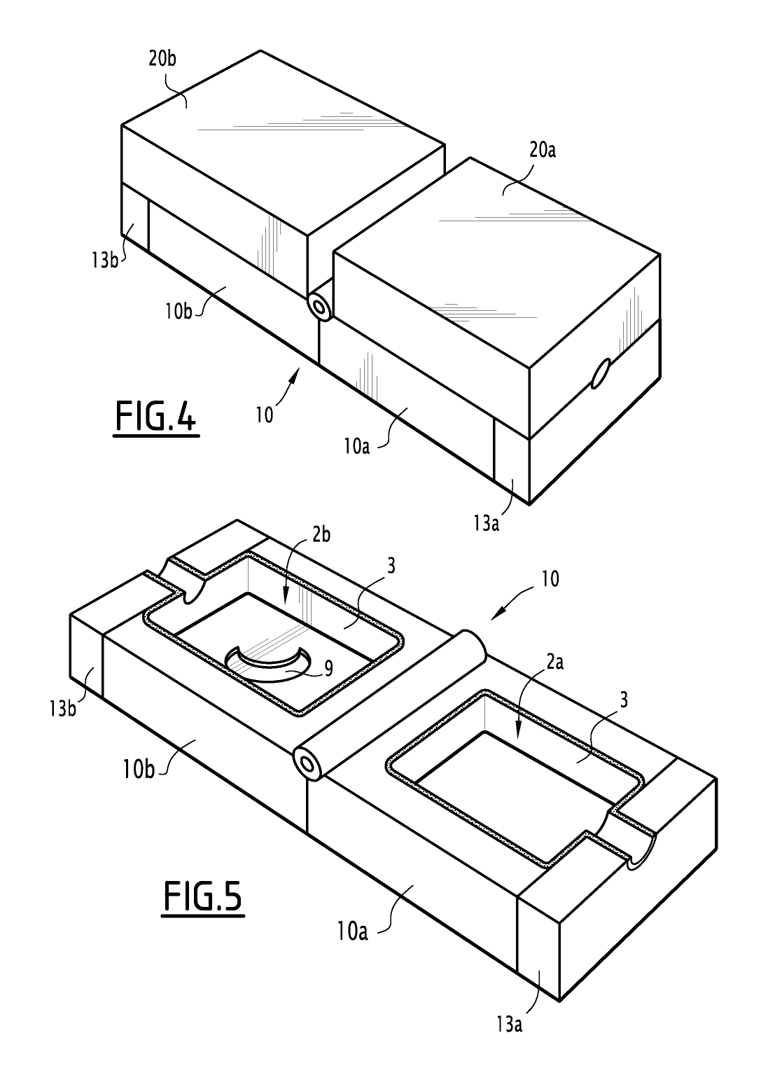

FIGS. 4 to 8 are schematic, perspective views showing the different steps of manufacture of the glass bottle using the installation conforming to the invention.

FIG. 1 schematically illustrates a glass bottle having general reference number 1 and which, in this example, is of general parallelepiped shape and comprises a body 2 with side walls 3, a bottom 4 and an upper part 5 opposite the bottom 4 and provided with a ring 6.

The bottle 1 may have any other general shape, such as cylindrical or ovoid for example.

According to one variant, the upper part 5 of the body 2 may be provided with a simple orifice without a ring 6, and in this case a pump, not illustrated, can be directly mounted on this orifice.

In the remainder hereof the description will be given for a bottle 1 provided with a ring 6.

The bottle 1 is obtained by hot pressing two symmetrical semi-bodies 2a and 2b as will be seen below.

With reference now to FIGS. 2 to 8, a description is given of the installation used to manufacture a bottle 1 such as previously described.

As shown in FIG. 2, the installation inter alia comprises a blank mould 10 formed of two semi-shells 10a and 10b each comprising a cavity 11 of shape substantially corresponding to the outer shape of a semi-body 2a or 2b of the body 2 of the bottle 1.

Evidently, the outer and inner shapes of the body 2 may be different.

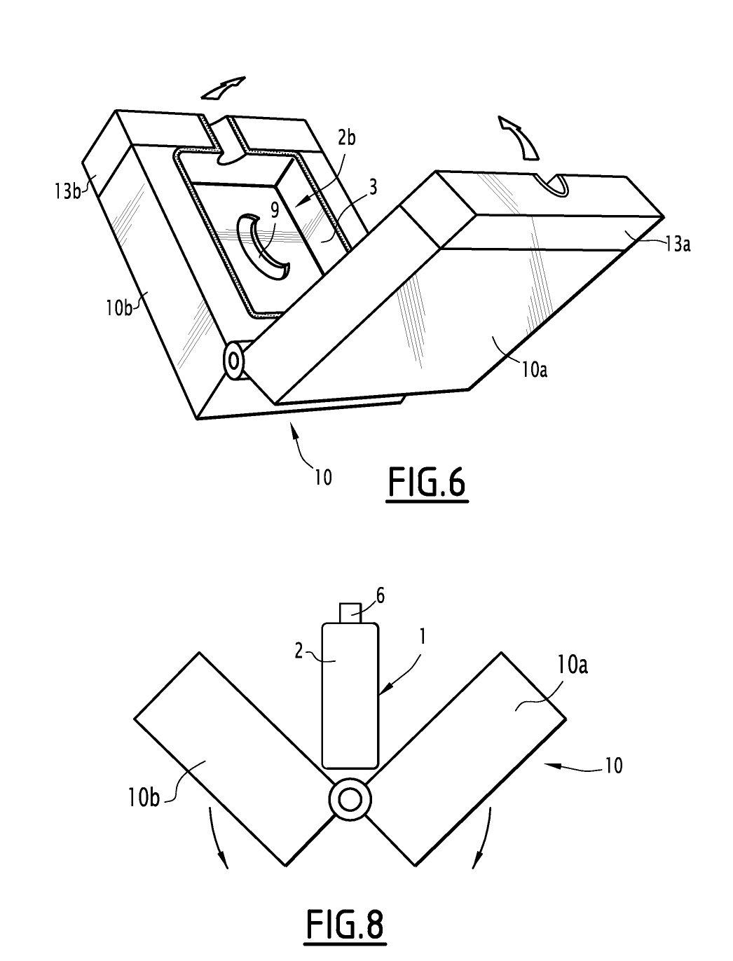

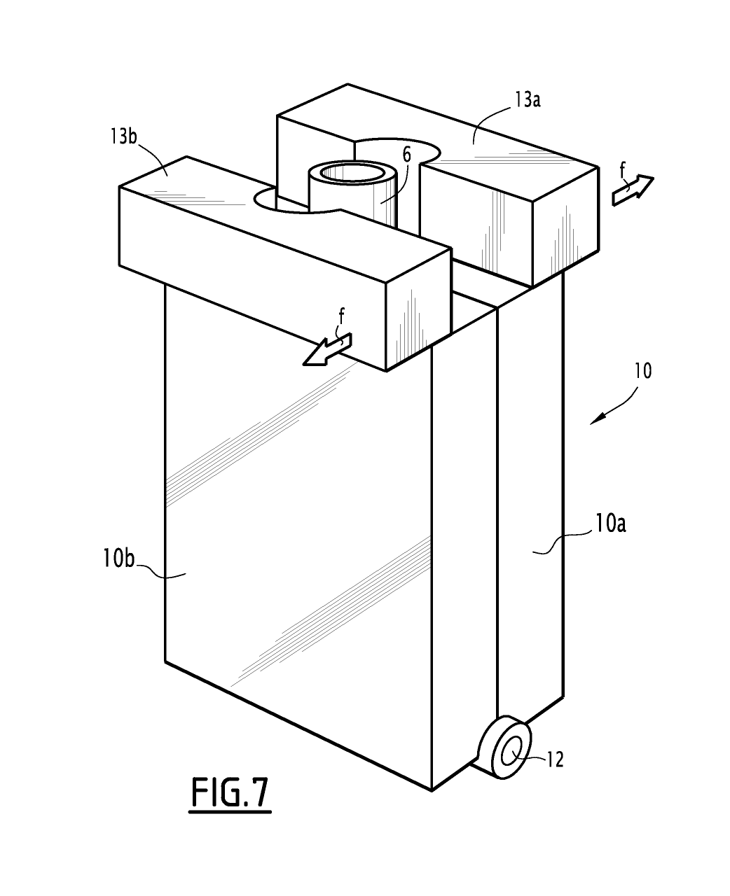

The two semi-shells 10a and 10b can be moved between a drawn-away position, as shown in FIG. 2, and a position in which they are applied against one another as shown in FIGS. 6 and 7.

For example, the two semi-shells 10a and 10b are pivot mounted on a pin 12 allowing them to be moved between these two positions. Other means of known type can be used to move these two semi-shells 10a and 10b between the two positions.

In addition, each semi-shell 10a and 10b comprises a drawer, respectively 13a and 13b which can be moved in the direction of the arrow f to release the ring 6 before the body 2 of the bottle 1. For this purpose, each drawer 13a and 13b is slidingly mounted on the corresponding semi-shell 10a and 10b by means of runners for example or any other suitable system of known type.

As shown in FIG. 3, the installation also comprises two punches 20a and 20b each comprising a form 21 in relief substantially corresponding to the cavity 11. At least one form 21 may comprise at least one raised or recessed pattern 22 so as to imprint this raised or recessed pattern 22 onto an inner surface of at least one wall of one or both semi-bodies 2a and 2b.

According to one variant, the installation comprises at least one punch which can be moved between a passive position and an active applied position in the cavity of each semi-shell.

To produce the bottle 1 formed of two hot-bonded semi-bodies 2a and 2b, the procedure is as follows:

First, and as shown in FIG. 2, a gob of glass 8 is deposited in the cavity 11 of each semi-shell 10a and 10b of the blank mould 10.

The two semi-bodies 2a and 2b are then simultaneously formed in the cavities 11 of the two semi-shells 10a and 10b by applying the punches 20a and 20b onto the semi-shells 10a and 10b of the blank mould 10.

The forms 21 in relief are applied in the cavities 11 thereby allowing distribution of the glass within the corresponding cavity 11 and the defining of the walls 3 of each semi-body 2a and 2b and of each semi-ring of the ring 6.

After removing each punch 20a and 20b from the corresponding semi-shell 11a and 11b of the blank mould 10, as shown in FIG. 6, each cavity 11 contains a semi-body 2a and 2b intended to be assembled onto one another to form the bottle 1.

The two semi-shells 10a and 10b of the blank mould 10 are drawn towards each other and applied against one another for example by pivoting on the pin 12 or any other suitable movement.

These two semi-shells 10a and 10b are applied against one another for a determined time to apply sufficient, determined pressure on the edges of the two semi-bodies 2a and 2b and obtain hot-welding together of these edges.

The edges of the two semi-bodies 2a and 2b must be at a determined temperature, e.g. of the order of 600° C. depending on the composition of the glass.

If the temperature of the glass on the edges of the two semi-bodies 2a and 2b is insufficient to achieve hot-welding together of these edges, re-heating may be performed using suitable means so as to bring the temperature of these edges up to a determined level allowing their welding together. These means may be formed for example of a blowtorch mounted on a jack to bring the torch close to the surface to be heated, or of a heating resistance.

The temperature to be reached must allow local re-melting of the glass.

Air blowing can also be carried out into the blank of the bottle after applying the edges of the two semi-bodies against one another.

After holding the two semi-shells 10a and 10b applied against each other for a determined time suitable for each model, the drawers 13 and 13b of these two semi-shells 10a and 10b are drawn outwards as shown in FIG. 7 so as first to release the ring 6 of the bottle 1. The ring 6 can be used to grasp the bottle 1 e.g. using a manipulator arm, not illustrated, to ensure the transfer thereof.

At a second stage, the two semi-shells 10a and 10b of the blank mould 10 are separated from each other, for example by pivoting on the pin 12, thereby allowing the release of the body 2 of the bottle 1, as illustrated in FIG. 8.

The bottle 1 thus obtained can be transferred using a manipulator arm for example, not illustrated and of known type, towards a finishing mould in which at least one finishing operation is performed e.g. burning off the junction point between the two semi-bodies 2a and 2b of the body 2 and the two semi-rings of the ring 6. Other finishing operations can also be carried out.

The bottle 1 optionally comprises at least one raised or recessed pattern 9 on at least one inner surface of these walls, thereby allowing personalization of the bottle in relation to the user trademark for example or the product contained in this bottle.

According to a first variant, the two semi-bodies 2a and 2b formed by the blank mould 10 can be transferred using at least one manipulator arm, not illustrated, to a finishing mould, not illustrated, in which the edges of these two semi-bodies are hot-welded together. For this purpose, the finishing mould is also formed of two semi-shells each comprising a cavity each substantially corresponding to a semi-body.

In this case also, re-heating of the edges of the two semi-bodies 2a and 2b may be conducted before applying the two semi-bodies against each other under determined pressure.

According to a second variant, the two semi-bodies 2a and 2b obtained after forming in the blank mould 10 can be transferred e.g. using at least one manipulator arm, not illustrated, to a suitable device allowing the edges of the two semi-bodies 2a and 2b to be applied against one another under determined pressure so as to achieve hot-welding thereof. In this case also, re-heating of the edges of the walls of the two semi-bodies 2a and 2b may also be carried out.

According to another embodiment, a sheet of composition close to that of the constituent glass of the two semi-bodies may be placed between the edges of these two semi-bodies before they are applied onto each other.

The manufacturing method and installation according to the invention offer new possibilities in terms of bottle-making by proposing the obtaining of bottles comprising raised or recessed patterns on the inner surfaces of this bottle, using means that are easy to implement.

1. A method for manufacturing a glass bottle (1) comprising a body (2) particularly including a bottom (4) and side walls (3), characterized in that it consists of the following steps:
a) a gob of glass (8) is deposited in a cavity (11) of a first semi-shell (10a) of a blank mould (10), and a gob of glass (8) is deposited in a cavity (11) of a second semi-shell (10b) of the blank mould (10), each cavity (11) having a shape substantially corresponding to the outer shape of a semi-body (2a, 2b) of the said body (2),
b) the semi-body (2a, 2b) is formed in a cavity (11) of each semi-shell (10a, 10b) by applying a punch (20a, 20b) to distribute the glass within the corresponding cavity (11) and to define the walls of each semi-body (2a, 2b), and by means of at least one of said punches (20a, 20b) at least one raised or recessed pattern is formed on an inner surface of at least one wall of at least one semi-body (2a, 2b); and
c) the edges of the two semi-bodies (2a, 2b) are applied against each other by applying a determined pressure to hot-weld these edges of the two semi-bodies (2a, 2b) with each other and obtain the bottle (1).

2. The method according to claim 1 characterized in that, in the cavity (11) of a semi-shell (10a, 10b), a semi-body (2a, 2b) is formed provided with a ring (6).

3. The method according to claim 1, characterized in that in the cavity (11) of each semi-shell (10a, 10b) a semi-body (2a, 2b) is formed provided with a semi-ring so that, after hot-welding the edges of the semi-bodies (2a, 2b) and of the semi-rings, a bottle is obtained comprising a body (2) provided with a ring (6).

4. The method according to claim 1, characterized in that by means of said punches (20a, 20b) at least one raised or recessed pattern is formed on an inner surface of at least one wall of each semi-body (2a, 2b).

5. The method according to claim 1, characterized in that step c) is performed directly in the blank mould (10) by applying the two semi-shells (2a, 2b) against one another.

6. The method according to claim 1, characterized in that after step b), the two semi-bodies (2a, 2b) are transferred to a finishing mould and step c) is performed.

7. The method according to claim 1, characterized in that after step b) the two semi-bodies (2a, 2b) are extracted from the semi-shells (10a, 10b) of the blank mould and step c) is performed.

8. The method according to claim 1, characterized in that, after step c), the body (2) is transferred to a finishing mould and at least one finishing step is performed.

9. The method according to claim 1 characterized in that, before step c), the edges of the two semi-bodies (2a, 2b) are re-heated and said step c) is performed.

10. The method according to claim 1, characterized in that air is blown into the inside of the body (2) during step c).

11. An installation for manufacturing a glass bottle (1) to implement the method according to any of the preceding claims, characterized in that it comprises:
a blank mould (10) formed of two semi-shells (10a, 10b) each comprising a cavity (11) of shape substantially corresponding to the outer shape of a semi-body (2a, 2b) of said body (2),
means for depositing a gob of glass (8) in the cavity (11) of each semi-shell (10a, 10b);
at least one punch (20a, 20b) able to be moved between a passive position and an active applied position in the cavity (11) of each semi-shell (10a, 10b) to distribute the glass within the cavity (11) and to define the inner and outer walls of each semi-body (2a, 2b), the or each punch (20a, 20b) comprising at least one raised or recessed pattern (22) to form the said at least one raised or recessed pattern (9) on an inner surface of at least one wall of at least one semi-body (2a and 2b); and
means for applying the edges of the two semi-shells (2a, 2b) on each other by applying a determined pressure to hot-weld these edges of the two semi-bodies (2a, 2b) with one another and to obtain the bottle (1).

12. The installation according to claim 11, characterized in that the means for applying together the edges of the two semi-bodies (2a, 2b) are formed by the two semi-shells (10a, 10b) of the blank mould (10).

13. The installation according to claim 11, characterized in that it comprises means for transferring each semi-body (2a and 2b) to a semi-shell of a finishing mould, and the means for applying together the edges of the two semi-bodies (2a, 2b) are formed by the two semi-shells of the finishing mould.

14. The installation according to characterized in that it comprises at least one element for re-heating the edges of the two semi-bodies (2a, 2b) before applying these edges of said semi-bodies (2a, 2b) one against the other.
